(19) United States
(12) Patent Application Publication
(10) Pub. No.: US 2019/0297557 A1
(43) Pub. Date: Sep. 26, 2019

(54) WIRELESS TRANSMISSION DEVICE, SYSTEM AND METHOD HAVING REPEATING AND ROUTING FUNCTIONS

(71) Applicant: Mars Semiconductor Corp, Hsinchu (TW)

(72) Inventor: Ming-Liang CHUNG, Hsinchu (TW)

(73) Assignee: Mars Semiconductor Corp, Hsinchu (TW)

(21) Appl. No.: 15/928,258

(22) Filed: Mar. 22, 2018

(51) Int. Cl. H04W 40/22; H04W 28/04

(52) U.S. Cl. CPC H04W 40/22; H04W 88/04; H04W 28/04

(57) ABSTRACT

A wireless transmission device includes a wireless transmission module, a sensing module, a memory module, and a processing module. A wireless transmission system includes a plurality of transmission units and a main control unit. The transmission units are based on the wireless transmission device. Through the wireless transmission device and system of the present invention, when the data transmission of the main control unit and any one of the transmission units fails, another transmission unit having the strongest signal or the highest transmission efficiency transmits data to the transmission unit whose data transmission fails. Thereby, the wireless transmission node of the present invention has repeating and routing functions, thereby improving transmission efficiency and accuracy in wireless communication.

### FIELD OF THE INVENTION

The present invention relates to a wireless communication technology, and more particularly, to a wireless transmission device, system and method having repeating and routing functions.

### BACKGROUND OF THE INVENTION

In the communication field, routers and repeaters are commonly used communication devices. The router is a telecommunication network device whose main purpose is to provide two important mechanisms, routing and forwarding. The job is to determine the transmission path through which a packet travels from a host to a server.

The work performed by the repeater is to receive an input signal from the host and then amplify the input signal, that is, the input signal is performed with frequency conversion or power amplification, and finally the input signal is sent to another repeater or a server. The purpose is to strengthen the input signal that is gradually weakened due to the long distance transmission so that the input signal can be transmitted farther, thereby increasing the transmission distance of the input signal.

When a wireless transmission signal is transmitted, in general, it needs to designate a wireless transmission apparatus first and set the wireless transmission apparatus as a repeater mode, so that the wireless transmission apparatus can serve as an exclusive repeater device to increase the transmission distance of the wireless transmission signal. As shown in FIG. 1, a conventional wireless transmission system 100 comprises a host 101, a repeater device 102, and a plurality of nodes 103-105.

The host 101 can perform a wireless signal transmission with the node 105 within a normal wireless signal transmission range. The repeater device 102 is a wireless transmission apparatus that has been set as a repeater mode to receive a wireless transmission signal from the host 101, and then the wireless transmission signal is amplified and sent to the node 103 or the node 104. In this way, through the repeater device 102, the conventional wireless transmission system 100 can successfully achieve the purpose of amplifying the wireless transmission signal that is gradually weakened due to the long-distance transmission, so that the wireless transmission signal can be transmitted farther.

However, although the conventional wireless transmission system can overcome the problem that the wireless transmission signal is gradually weakened due to the long-distance transmission. However, a wireless transmission apparatus must be designated in advance between the host and the long-distance node. The wireless transmission apparatus is set to a repeater mode. The process is too complicated and lengthy. Through a single repeater device to bear the long-distance wireless signal transmission, the overall risk is too large. For example, once the repeater device fails, the operation of the entire system will be paralyzed, so the conventional wireless transmission system needs to be improved. Accordingly, the inventor of the present invention has devoted himself based on his many years of practical experiences to solve these problems.

### SUMMARY OF THE INVENTION

In view of this, the primary object of the present invention is to provide a wireless transmission device, system and method which have repeating and routing functions. The wireless transmission device serves as a node of the wireless transmission system and performs the wireless transmission method. Through the node having the functions of a router and a repeater, once encountering the problem that the wireless transmission signal is gradually weakened due to long-distance transmission, the node itself performs the function of the repeater. It is not necessary to designate a wireless transmission apparatus between the host and the long-distance wireless transmission node in advance and to set the wireless transmission apparatus as the repeating mode, so that the transmission efficiency and accuracy of the wireless communication can be improved.

According to one aspect of the present invention, a wireless transmission device having repeating and routing functions comprises a wireless transmission module, a sensing module, a memory module, and a processing module. The wireless transmission module is configured to receive data of a radio frequency transmission from a source end and transmit the data to a destination end. The sensing module is configured to detect the signal strength between the wireless transmission module and the source end or the destination end. The memory module is configured to store information of the data, the source end and the destination end. The processing module is configured to perform frequency conversion or power amplification for the data of the radio frequency transmission. Wherein, the wireless transmission module is connected to a main control network of a main control unit to perform a data transmission with the main control unit.

According to another aspect of the present invention, a wireless transmission system having repeating and routing functions is provided. The wireless transmission system comprises a plurality of transmission units and a main control unit. Wherein each transmission unit is capable of receiving data of a radio frequency transmission from a source end and storing the data and then transmitting the data to a destination end. The main control unit has a main control network connected to the transmission units and is capable of performing a data transmission with the transmission units respectively. In addition, the source end or the destination end is the main control unit or any one of the transmission units. The transmission units respectively perform frequency conversion or power amplification for the data of the radio frequency transmission before transmitting the data.

According to a further aspect of the present invention, a wireless transmission method having repeating and routing functions is provided. The wireless transmission method comprises the steps of: a plurality of transmission units being connected to a main control network of a main control unit respectively; when a data transmission of the main control unit and any one of the transmission units fails, the main control unit learning the transmission unit having the strongest signal or the highest transmission efficiency among the other transmission units with the transmission unit whose data transmission fails; the transmission unit having the strongest signal receiving data of a radio frequency transmission from the main control unit and storing the data and then transmitting the data to the transmission unit whose data transmission fails. Wherein, the transmission unit having the strongest signal performs frequency conversion or power amplification of the data of the radio frequency transmission before transmitting the data.

Preferably, the main control unit is able to determine whether the transmission units receive or transmit the data and to determine the time for the transmission units or the wireless transmission module to receive or transmit the data.

Preferably, the main control unit is able to decide to perform the data transmission with one or more of the transmission units.

Preferably, when the data transmission of the main control unit and any one of the transmission units fails, the main control unit notifies the transmission units individually or notifies the wireless transmission module, and learns the signal strength of each of the transmission units or the signal strength of the wireless transmission module after the transmission units or the wireless transmission module receives a notification.

Preferably, only one of the transmission units performs the data transmission with the main control unit or another one of the transmission units at the same time, or the wireless transmission module performs the data transmission with the main control unit or another wireless transmission module at the same time.

### BRIEF DESCRIPTION OF THE DRAWINGS

FIG. 1 is a block diagram of a conventional wireless transmission system;

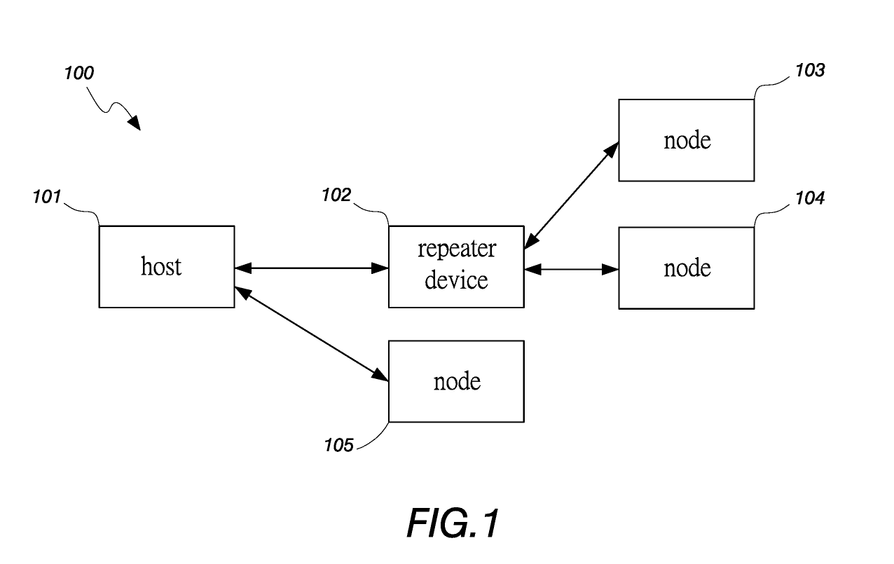

FIG. 2 is a block diagram of the wireless transmission device according to the present invention;

FIG. 3 is a first block diagram of the wireless transmission system according to the present invention;

FIG. 4 is a second block diagram of the wireless transmission system according to the present invention; and

FIG. 5 illustrates the flow chart of the wireless transmission method according to the present invention.

### DETAILED DESCRIPTION OF THE PREFERRED EMBODIMENTS

Advantages and features of the inventive concept and methods of accomplishing the same may be understood more readily by reference to the following detailed description of embodiments and the accompanying drawings. The inventive concept may, however, be embodied in many different forms and should not be construed as being limited to the embodiments set forth herein.

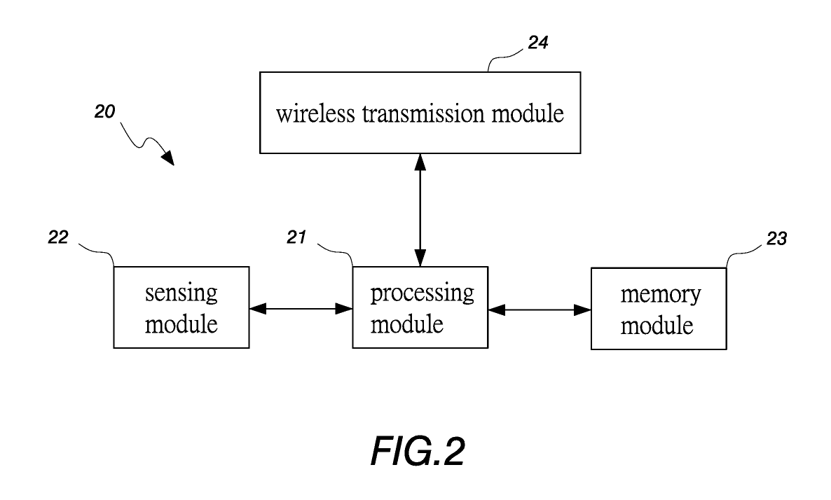

FIG. 2 shows a block diagram of a wireless transmission device 20 according to the present invention.

The wireless transmission device 20 of the present invention comprises a wireless transmission module 24, a sensing module 22, a memory module 23, and a processing module 21. The wireless transmission module 24 is configured to receive data of a radio frequency transmission from a source end and transmit the data to a destination end. The sensing module 22 is configured to detect the signal strength between the wireless transmission module 24 and the source end or the destination end. The memory module 23 is configured to store the information of the data, the source end and the destination end. The processing module 21 is configured to perform frequency conversion or power amplification for the data of the radio frequency transmission.

According to the above configuration, the wireless transmission module 24 provides two mechanisms, routing and forwarding, for the wireless transmission device 20, which determines the transmission path through which a packet travels from the source end to the destination end. The memory module 23 provides a function of storing the packet. In addition, the processing module 21 has a function of frequency conversion and power amplification. After the wireless transmission module 24 receives an input signal from the source end and the input signal is processed by the processing module 21, the input signal may be amplified. In this way, the input signal gradually weakened due to the long-distance transmission can be strengthened, so that the input signal can be transmitted farther, thereby increasing the transmission distance of the input signal. Therefore, the wireless transmission device 20 of the present invention combines the functions of a repeater and a router.

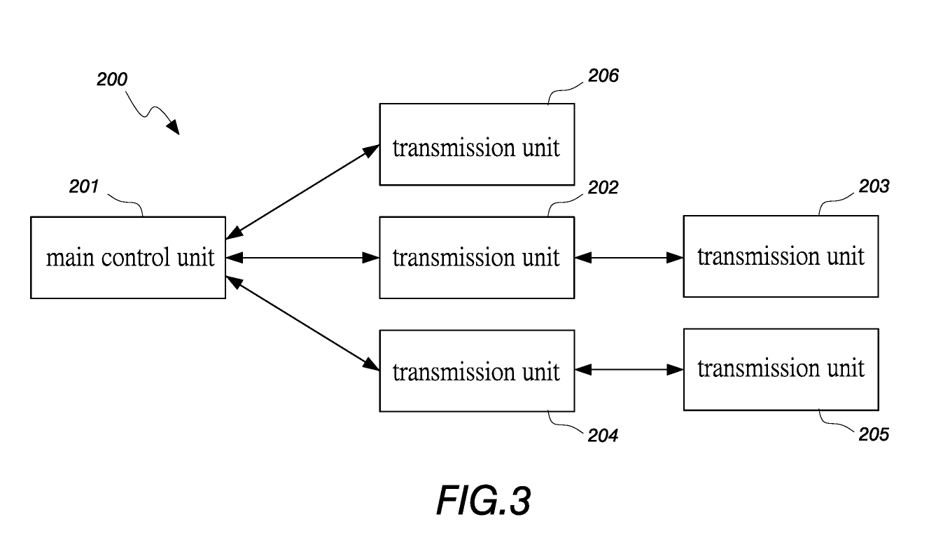

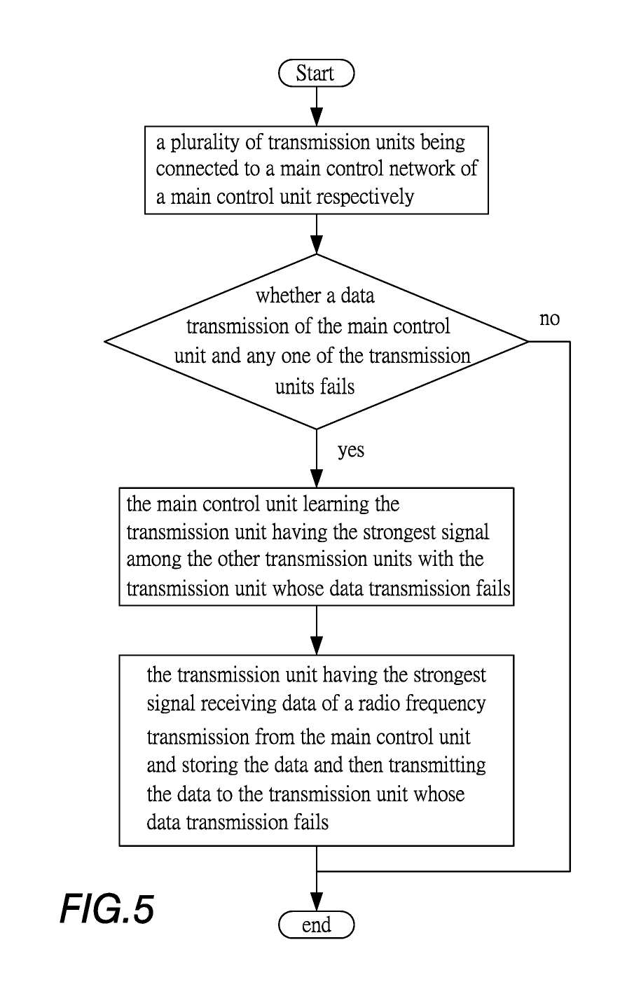

Please refer to FIG. 3 and FIG. 5. FIG. 3 is a first block diagram of the wireless transmission system 200 of the present invention. FIG. 5 illustrates the flow chart of the wireless transmission method according to the present invention.

The wireless transmission system 200 of the present invention comprises a plurality of transmission units 202-206 and a main control unit 201. Since the transmission units 202-206 of the present invention are based on the wireless transmission device 20 respectively, all of the transmission units 202-206 have the functions of the repeater and the router, that is, the transmission units 202-206 respectively receive data of a radio frequency transmission from a source end and store the data and then transmit the data to a destination end. The transmission units 202-206 respectively perform frequency conversion or power amplification for the data of the radio frequency transmission before transmitting the data.

As described above, the main control unit 201 has a main control network connected to the transmission units and can perform a data transmission with each of the transmission units 202-206. Therefore, in theory, the source end or the destination end may be the main control unit 201 or any one of the other transmission units 202-206. In this embodiment, however, the main control unit 201 serves as the source end of the highest layer, and any one of the transmission units 202-206 serves as the destination end relative to the main control unit 201.

In theory, any one of the transmission units 202-206 can play the role of a repeater, namely, performing frequency conversion or power amplification for the data of the radio frequency transmission mentioned above. As shown in FIG. 3, the transmission unit 202 plays such a role. Because of the distance problem, the main control unit 201 cannot directly transmit the data to the transmission unit 203, so the data is transmitted to the transmission unit 202 first. After the transmission unit 202 receives the data, the data can be transmitted to the transmission unit 203 timely so as to enable the main control unit 201 to transmit the data to the transmission unit 203.

In addition to the actual operation in this embodiment, the transmission units 204, 206 may play the role of a repeater as the transmission unit 202. However, in the further definition of this embodiment, the main control unit 201 may determine whether each of the transmission units 202-206 receives or transmits the data and may determine the time for each of the transmission units 202-206 to receive or transmit the data. The main control unit 201 may further decide to perform the data transmission with one or more of the transmission units 202-206.

As shown in FIG. 5, when the data transmission of the main control unit 201 and any one of the transmission units 202-206 fails, the main control unit 201 notifies the transmission units 202-206 individually and learns the signal strength of each of the transmission units 202-206 after each of the transmission units 202-206 receive the notification. It is worth mentioning that in the wireless transmission system 200 of the present invention only one of the transmission units 202-206 performs the data transmission with the main control unit 201 or another one of the transmission units 202-206 at the same time. This is to avoid collisions caused by using the same radio frequency and to improve the transmission efficiency and accuracy of the radio frequency.

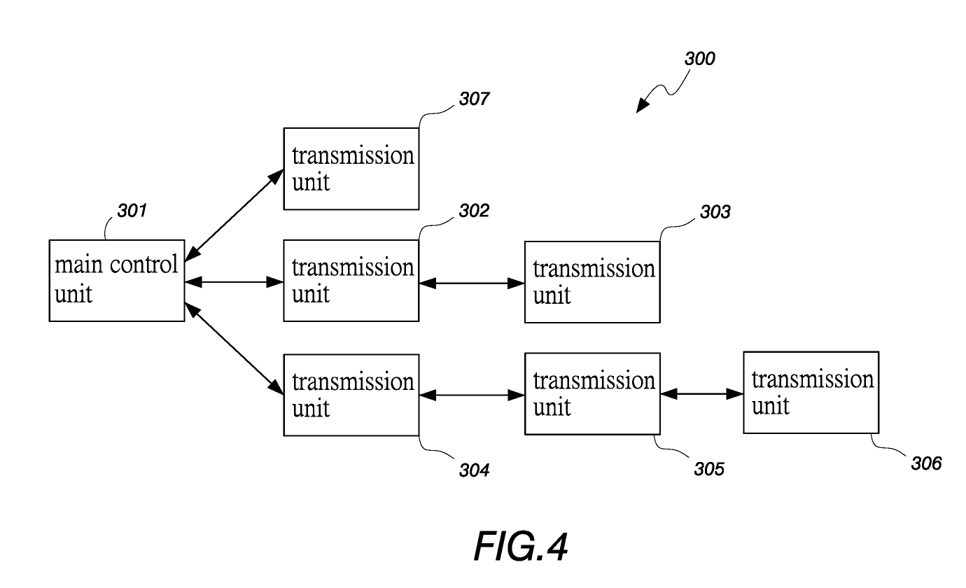

Please refer to FIG. 4 and FIG. 5 again. FIG. 4 shows a second block diagram of the wireless transmission system 300 according to the present invention.

As the embodiment of FIG. 3, in the wireless transmission system 300, in theory, any one of the transmission units 302-307 can play the role of a repeater, namely, performing frequency conversion or power amplification for the data of the radio frequency transmission mentioned above. As shown in FIG. 4, the transmission units 302, 304, 305 play such a role. Because of the distance problem, the main control unit 301 cannot directly transmit the data to the transmission unit 303, so the data is transmitted to the transmission unit 302 first. After the transmission unit 302 receives the data, the data can be transmitted to the transmission unit 303 timely so as to enable the main control unit 301 to transmit the data to the transmission unit 303.

As described above, because of the problem of distance, the main control unit 301 cannot directly transmit the data to the transmission unit 303, so the data is transmitted to the transmission unit 304 first. After the transmission unit 304 receives the data, the data can be transmitted to the transmission unit 305 timely. After the transmission unit 305 receives the data, the data can be transmitted to the transmission unit 306 timely so as to enable the main control unit 301 to transmit the data to the transmission unit 306.

Finally, please refer to FIG. 3, FIG. 4 and FIG. 5. The wireless transmission method of the present invention comprises the following steps in sequence. First, as the establishment of the foregoing wireless transmission system 200 or 300, the transmission units 202-206 or 302-307 are connected to the main control network of the main control unit 201 or 301, respectively. After that, when the data transmission of the main control unit 201 or 301 and any one of the transmission units 202-206 or 302-307 fails, the main control unit 201 or 301 will learn the transmission unit having the strongest signal or the highest transmission efficiency among the other transmission units with the transmission unit whose data transmission fails (for example, the transmission unit 202 in FIG. 3 or the transmission unit 302, 304, and 305 in FIG. 4). Finally, the transmission unit having the strongest signal receives the data of the radio frequency transmission from the main control unit 201 or 301 and stores the data and then transmits the data to the transmission unit whose data transmission fails (for example, the transmission unit 203 in FIG. 3 or the transmission unit 303 and 306 in FIG. 4).

In summary, the wireless transmission device, system and method of the present invention have the functions of a router and a repeater though a wireless transmission node (namely, the wireless transmission device and the transmission unit). Once encountering the problem that the wireless transmission signal is gradually weakened due to the long distance during the long distance transmission, the function of the repeater can be directly performed through the wireless transmission node itself. It is not necessary to designate a wireless transmission apparatus between the host (namely, the main control unit) and the long-distance wireless transmission node in advance and to set the wireless transmission apparatus as the repeating mode, so that the transmission efficiency and accuracy of the wireless communication can be surely improved to solve the problems of the prior art.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A wireless transmission system having repeating and routing functions, comprising:
a plurality of transmission units, each capable of receiving data of a radio frequency transmission from a source end and storing the data and then transmitting the data to a destination end;
a main control unit, having a main control network connected to the transmission units and being capable of performing a data transmission with the transmission units respectively;
wherein the source end or the destination end is the main control unit or any one of the transmission units; the transmission units respectively perform frequency conversion or power amplification for the data of the radio frequency transmission before transmitting the data.

2. The wireless transmission system as claimed in claim 1, wherein the main control unit is able to determine whether the transmission units receive or transmit the data and to determine the time for the transmission units to receive or transmit the data.

3. The wireless transmission system as claimed in claim 1, wherein the main control unit is able to decide to perform the data transmission with one or more of the transmission units.

4. The wireless transmission system as claimed in claim 1, wherein when the data transmission of the main control unit and any one of the transmission units fails, the main control unit notifies the transmission units individually and learns the signal strength of each of the transmission units after the transmission units receive a notification.

5. The wireless transmission system as claimed in claim 1, wherein only one of the transmission units performs the data transmission with the main control unit or another one of the transmission units at the same time.

6. A wireless transmission method having repeating and routing functions, comprising the steps of:
(A) a plurality of transmission units being connected to a main control network of a main control unit respectively;
(B) when a data transmission of the main control unit and any one of the transmission units fails, the main control unit learning the transmission unit having the strongest signal or the highest transmission efficiency among the other transmission units with the transmission unit whose data transmission fails;
(C) the transmission unit having the strongest signal receiving data of a radio frequency transmission from the main control unit and storing the data and then transmitting the data to the transmission unit whose data transmission fails;
wherein the transmission unit having the strongest signal performs frequency conversion or power amplification of the data of the radio frequency transmission before transmitting the data.

7. The wireless transmission method as claimed in claim 6, wherein the main control unit is able to determine whether the transmission units receive or transmit the data and to determine the time for the transmission units to receive or transmit the data.

8. The wireless transmission method as claimed in claim 6, wherein the main control unit is able to decide to perform the data transmission with one or more of the transmission units.

9. The wireless transmission method as claimed in claim 6, wherein when the data transmission of the main control unit and any one of the transmission units fails, the main control unit notifies the transmission units individually and learns the signal strength of each of the transmission units after the transmission units receive a notification.

10. The wireless transmission method as claimed in claim 6, wherein only one of the transmission units performs the data transmission with the main control unit or another one of the transmission units at the same time.

11. A wireless transmission device having repeating and routing functions, comprising:
a wireless transmission module, configured to receive data of a radio frequency transmission from a source end and transmit the data to a destination end;
a sensing module, configured to detect the signal strength between the wireless transmission module and the source end or the destination end;
a memory module, configured to store information of the data, the source end and the destination end;
a processing module, configured to perform frequency conversion or power amplification for the data of the radio frequency transmission.

12. The wireless transmission device as claimed in claim 11, wherein the wireless transmission module is connected to a main control network of a main control unit to perform a data transmission with the main control unit.

13. The wireless transmission device as claimed in claim 12, wherein the main control unit is able to determine whether the wireless transmission module receives or transmits the data and to determine the time for the wireless transmission module to receive or transmit the data.

14. The wireless transmission device as claimed in claim 12, wherein when the data transmission of the main control unit and the wireless transmission module fails, the main control unit learns the signal strength of the wireless transmission module.

15. The wireless transmission device as claimed in claim 12, wherein the wireless transmission module performs the data transmission with the main control unit or another wireless transmission module at the same time.
